(19) United States
(12) Patent Application Publication
(10) Pub. No.: US 2013/0169907 A1
(43) Pub. Date: Jul. 4, 2013

(54) CURVED DISPLAY PANEL AND METHOD FOR FORMING THE SAME

(71) Applicants: CHUNG-WEI WANG, Tu-Cheng (TW); CHIU-HSIUNG LIN, Tu-Cheng (TW)

(72) Inventors: CHUNG-WEI WANG, Tu-Cheng (TW); CHIU-HSIUNG LIN, Tu-Cheng (TW)

(73) Assignee: HON HAI PRECISION INDUSTRY CO., LTD., Tu-Cheng (TW)

(21) Appl. No.: 13/534,183

(22) Filed: Jun. 27, 2012

(30) Foreign Application Priority Data
Dec. 29, 2011 (CN) 201110450158.5

(51) Int. Cl. G02F 1/1335; B29C 43/20

(52) U.S. Cl. 349/96; 264/241

(57) ABSTRACT

A curved display panel includes a top polarizer, a curved top glass plate, a color filter, a liquid-crystal layer, a thin-film transistor layer including an array of thin-film transistors, a curved bottom glass plate, and a bottom polarizer. The color filter, the liquid-crystal layer, and the thin-film transistor array are sandwiched between the curved top glass plate and the curved bottom glass plate. The top polarizer is located on an opposite surface of the curved top glass plate to the color filter, and the bottom polarizer is located at an opposite surface of the curved bottom glass plate to the thin-film transistor layer. The disclosure also discloses a method for forming a curved display panel.

### BACKGROUND

1. Technical Field

The present disclosure relates to display panels, in particularly to a curved display panel and a method for forming the curved display panel.

2. Description of Related Art

Many display panels are planar. A display panel is typically mounted within a frame. In certain circumstances, a curved display panel has advantages over a planar display panel, such as when being used in an outdoor, column mounted advertising system.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of a curved according to an exemplary embodiment.

FIG. 2 is a flowchart of a method for forming the curved display panel of FIG. 1.

### DETAILED DESCRIPTION

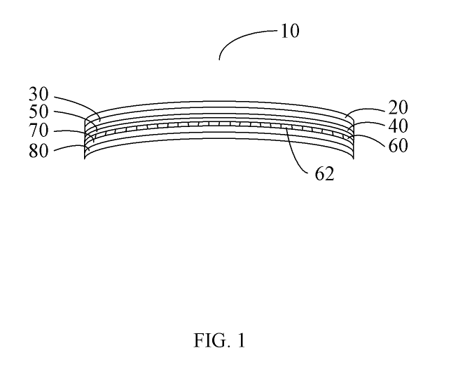

FIG. 1, is an exemplary embodiment of a curved display panel 10. The curved display panel 10 includes a top polarizer 20, a top glass plate 30, a color filter 40, a liquid-crystal layer 50, a thin-film transistor layer 60 including an array of thin-film transistors 62, a bottom glass plate 70 and a bottom polarizer 80.

The color filter 40, the liquid-crystal layer 50 and the thin-film transistor layer 60 are sandwiched between the top glass plate 30 and the bottom glass plate 70. The liquid-crystal layer 50 is sandwiched between the color filter 40 and the thin-film transistor layer 60. The top polarizer 20 is located on an opposite surface of the top glass plate 30 to the color filter 40, and the bottom polarizer 80 is located at an opposite surface of the bottom glass plate 70 to the thin-film transistor layer 60.

The top glass plate 30, the bottom glass plate 70, the top polarizer 20 and the bottom polarizer 80 are all curved. The curved glass plates and the curved polarizers are respectively formed by stretching planar glass plates and planar polarizers. When the planar glass plates are stretched, each area of the thin-film transistor 62 between the top glass plate 30 and the bottom glass plate 70 is extended. Because each thin-film transistor 62 corresponds to a pixel, the extended transistors 62 will cause the image displayed on the display panel 10 to be deformed. Thus, in order to avoid a deformed image displayed on the curved display panel 10, the thin-film transistors 62 between the top glass plate 30 and the bottom glass plate 70 are pre-compressed. A compression ratio of each thin-film transistor 62 is substantially equal to an expansion ratio of the thin-film transistor 62 when the planar glass plates are stretched from planar plates to curved plates.

For example, if the area of each thin-film transistor 62 is 2 square millimeters in its original state, and the area of the thin-film transistor 62 will become 4 square millimeters after being stretched, the expansion ratio of the thin-film transistor 62 is defined to be two. Thus, before the packaging of the thin-film transistors 62, the thin-film transistors 62 are pre-compressed and the compression ratio is 2, that is, the area of the pre-compressed thin-film transistors 62 is 1 square millimeter. In this way, after the top glass plate 30 and the bottom glass plate 70 are stretched, the area of the thin-film transistors 62 between the top glass plate 30 and the bottom glass plate 70 changes from 1 square millimeter to 2 square millimeters, which is the same as a normal, intact transistor. As a result, the curved display panel 10 can display normal images.

The curved display panel 10 can be mounted within an object with a curved surface corresponding to the curved display panel 10, which can enlarge a viewing angle.

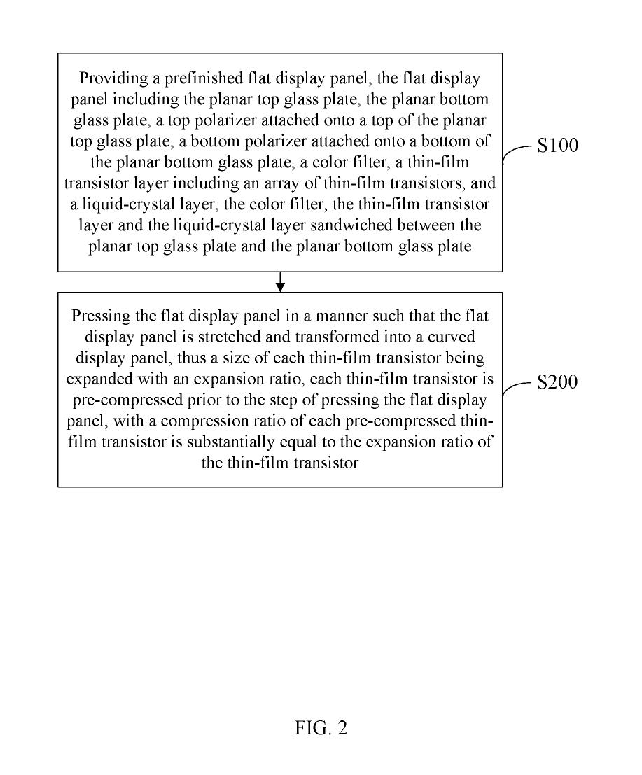

FIG. 2, is a flowchart of a method for forming a curved display panel 10.

In step S100, providing a prefinished flat display panel, the flat display panel including the planar top glass plate, the planar bottom glass plate, a top polarizer 20 attached onto a top of the planar top glass plate, a bottom polarizer 80 attached onto a bottom of the planar bottom glass plate, a color filter 40, a thin-film transistor layer 60 including an array of thin-film transistors 62, and a liquid-crystal layer 50, the color filter 40, the thin-film transistor layer 60 and the liquid-crystal layer 50 sandwiched between the planar top glass plate and the planar bottom glass plate.

In step S200, pressing the flat display panel in a manner such that the flat display panel is stretched and transformed into a curved display panel 10, thus a size of each thin-film transistor 62 being expanded with an expansion ratio, each thin-film transistor 62 is pre-compressed prior to the step of pressing the flat display panel, with a compression ratio of each pre-compressed thin-film transistor 62 is substantially equal to the expansion ratio of the thin-film transistor 62.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A curved display panel comprising:
a curved top glass plate;
a curved bottom glass plate;
a thin-film transistor layer comprising an array of thin-film transistors;
a color filter;
a liquid-crystal layer sandwiched between the color filter and the thin-film transistor layer;
a top polarizer; and
a bottom polarizer;
wherein the color filter, the liquid-crystal layer and the thin-film transistor layer are sandwiched between the top glass plate and the bottom glass plate, the top polarizer is located on an opposite surface of the curved top glass plate to the color filter, and the bottom polarizer is located at an opposite surface of the curved bottom glass plate to the thin-film transistor layer.

2. A method for forming a curved display panel, the method comprising:
providing a prefinished flat display panel, the flat display panel including a planar top glass plate, a planar bottom glass plate, a top polarizer attached onto a top of the planar top glass plate, a bottom polarizer attached onto a bottom of the planar bottom glass plate, a color filter, a thin-film transistor layer comprising an array of thin-film transistors, and a liquid-crystal layer, the color filter, the thin-film transistor layer and the liquid-crystal layer sandwiched between the planar top glass plate and the planar bottom glass plate; and
pressing the flat display panel in a manner such that the flat display panel is stretched and transformed into a curved display panel, thus a size of each thin-film transistor being expanded with an expansion ratio, wherein each thin-film transistor is pre-compressed prior to the step of pressing the flat display panel, with a compression ratio of each pre-compressed thin-film transistor is substantially equal to the expansion ratio of the thin-film transistor.
